(19) United States
(12) Patent Application Publication
(10) Pub. No.: US 2012/0216840 A1
(43) Pub. Date: Aug. 30, 2012

(54) ELECTRONIC COMPONENT CLEANING DEVICE AND CLEANING METHOD

(75) Inventor: Taishi Nishigaki, Osaka-shi (JP)

(73) Assignee: ARAKAWA CHEMICAL INDUSTRIES, LTD., Osaka (JP)

(21) Appl. No.: 13/508,004

(22) PCT Filed: Oct. 21, 2010
(86) PCT No.: PCT/JP2010/006241

§ 371 Date: May 3, 2012

(30) Foreign Application Priority Data
Nov. 3, 2009 (JP) 2009-252527

(51) Int. Cl. B08B 3/02

(52) U.S. Cl. 134/36; 134/198

(57) ABSTRACT

A plurality of spray units spray a cleaning liquid to a plurality of spray-target regions between which a site to be cleaned is interposed. The plurality of spray-target regions are linearly extending. The plurality of spray-target regions each has a spray pattern characterized in that a spray direction when viewed from a direction where the plurality of spray-target regions are linearly extending is perpendicular to a plane including the spray-target region. The spray units are disposed such that the plurality of spray-target regions are arranged in juxtaposition each other. The cleaning liquid sprayed from the spray units crashes against the plurality of spray-target regions and thereby generates cleaning liquid flows headed for the site to cleaned.

### FIELD OF THE INVENTION

The present invention relates to a device and a method for cleaning electronic components having narrow clearances therein, for example; substrates mounted with various semiconductor devices such as electronic circuit chip, transistor, capacitor, and diode.

### BACKGROUND OF THE INVENTION

An electronic component having a structure where electronic circuit chips (semiconductor devices) are mounted on a substrate (wafer) have finely-structured portions and narrow clearances at, for example, soldering sections between the substrate and the electronic circuit chips. These narrow clearances and finely-structured portions are hereinafter collectively called clearance. For example, a semiconductor mounting substrate of Flip Chip-Ball Grid Array packaging (FC-BGA) has a large number solder bumps on all of rear surfaces of the electronic circuit chips including semiconductor devices, wherein the solder bumps are melted and thereby bonded to the substrate. Because the clearance between the electronic circuit chip and the substrate is not more than about 0.05 mm, tiny wastes, such as flux used to bond the solder bumps to the substrate, solder residue, and metal impurity are often left in the clearance after the soldering is over. These wastes are likely to cause malfunction of the electronic component (for example, short circuit) and deterioration of yields. To avoid the problem, these wastes are removed by cleaning before the electronic component is sealed with a sealing agent to be shipped as an end product. However, it is conventionally difficult to penetrate a cleaning liquid into any site to be cleaned of the electronic component (for example, clearance) or make the wastes be eluted from the clearance. Thus, it is more difficult to thoroughly clean inside of the electronic component than cleaning its surface.

A method conventionally employed to clean a site to be cleaned of an electronic component is ultrasonic cleaning, wherein the wastes are fallen off and removed by ultrasonic wave. However, the ultrasonic cleaning has disadvantages; a desirable effect cannot be expected in any portions where the ultrasonic is hardly transmitted, and ultrasonic vibration may damage or break the electronic component. Therefore, the ultrasonic cleaning is not a suitable option that can be universally applied to the cleaning of electronic components.

Under the circumstances, a nozzle cleaning method was invented, wherein a cleaning liquid is sprayed through a cleaning nozzle toward corner portions of an electronic component to penetrate into the electronic component for cleaning it inside. According to the method, the cleaning liquid is poured into an electronic circuit chip (semiconductor device) by way of the substrate corner portions to generate a fast liquid flow along edges of the electronic circuit chip, and the penetration of the cleaning liquid into a site to be cleaned (for example, clearance) is accelerated because of a negative pressure in an edge of the narrow clearance in contact with the fast liquid flow (Patent Reference 1).

### PRIOR ART DOCUMENT

### Patent Reference

Patent Reference 1: Unexamined Japanese Patent Application Publication No. 11-300294

### SUMMARY OF THE INVENTION

### Problem to be Solved by the Invention

However, it is very difficult to automate cleaning and other processes of the conventional method, thereby failing to improve a cleaning efficiency.

The present invention provides a method and a device for cleaning an electronic component that both succeed in accomplishing a remarkable cleaning effect.

### Means for Solving the Problem

The present invention provides an electronic component cleaning device for cleaning a site to be cleaned of an electronic component, comprising a plurality of spray units respectively adapted to spray a cleaning liquid to a plurality of spray-target regions between which the site to be cleaned is interposed, wherein

the plurality of spray-target regions are linearly extending,

the plurality of spray-target regions each has a spray pattern characterized in that a spray direction when viewed from a direction where the plurality of spray-target regions are linearly extending is perpendicular to a plane including the spray-target region,

the plurality of spray units are disposed such that the plurality of spray-target regions are arranged in juxtaposition each other, and

the cleaning liquid sprayed from the plurality of spray units crashes against the plurality of spray-target regions and thereby generates cleaning liquid flows headed for the site to cleaned.

Describing “the plurality of spray-target regions are arranged in juxtaposition each other”, the plurality of spray-target regions may be literally in parallel with each other, or the plurality of spray-target regions may extend so as to intersect with each other through very small angles having an angular difference equal to or smaller than 5°. Describing “perpendicular to a plane including the spray-target region”, the direction may be literally perpendicular to the plane, or “perpendicular direction” may include directions having an angle ranging from 85° to 95° to the plane. The “linearly” is preferably the form of a straight line, however, may include the forms of a line curved with a moderate curvature and an undulated line.

The cleaning liquid sprayed from the spray units crashes against the spray-target regions and thereby diverges in different directions. Accordingly, cleaning liquid flows oppositely directed are formed along the plane including the spray-target regions, and an area where paired cleaning liquid flows are confronting each other (hereinafter called “liquid flow confronting area”) is formed at an intermediate position between the spray-target regions facing each other. When the spray units are disposed such that the site to be cleaned of the electronic component (for example, clearance formed in the electronic component) is located at the intermediate position between the adjacent spray-target regions, the cleaning liquid flows oppositely directed constituting the liquid flow confronting area pour into the site to be cleaned to clean the site.

To maximize the cleaning effect, the present invention preferably includes the following modes.

The site to be cleaned preferably includes a clearance of the electronic component exposed toward the spray-target regions.

A suitable electronic component that can be cleaned by the device according to the present invention has a substrate or a wafer and an electronic circuit chip mounted on the substrate or the wafer, wherein the clearance is formed between the substrate or the wafer and the electronic circuit chip.

The device preferably further comprises a transport unit adapted to transport the electronic component from one of the spray-target regions on two sides between which the site to be cleaned is interposed to the other spray-target region. When the electronic component is transported by the transport unit, the electronic component passes through the liquid flow confronting area where the different cleaning liquid flows are confronting each other (formed at the intermediate position between the spray-target regions facing each other. Accordingly, the site to be cleaned is cleaned consecutively with the two cleaning liquid flows directed in opposite directions.

An interval distance from one of the spray-target regions on two sides between which the site to be cleaned is interposed to the other spray-target region is preferably larger than a size of the site to be cleaned along a facing direction of the spray-target region on one of the two sides and the spray-target region on the other side. More specifically, the electronic component has a substrate or a wafer and an electronic chip mounted on the substrate or the wafer, wherein an interval distance D from one of the spray-target regions on two sides between which the site to be cleaned is interposed to the other spray-target region and a width dimension L of the electronic component along the facing direction of the spray-target region on one of the two sides and the spray-target region on the other side preferably fulfills a relationship expressed by the formula L<D≦(L+25 mm). Accordingly, the cleaning liquid flows oppositely directed can be more reliably poured into the site to be cleaned.

The transport unit preferably transports the electronic component at a transport rate from 100 to 1,500 mm/min. Such a transport rate effectively reduces adverse impacts possibly exerted on the cleaning effect by any interference between the electronic component being transported and the cleaning liquid flow. The transport rate thus set further ensures a satisfactory volume of production and leads to downsizing of the cleaning device.

A flow rate of the cleaning liquid flow is preferably from 0.03 m/sec. to 0.2 m/sec., and a spray pressure is preferably from 0.05 MPa to 0.8 MPa. Accordingly, a constant cleaning performance is reliably exerted, and breakage of the electronic component is prevented from happening.

The spray unit preferably includes a fan-type nozzle. The spray unit thus structured can easily and suitably adjust the flow rate of the cleaning liquid depending on an object to be cleaned (electronic component).

A cleaning liquid spray angle of the fan-type nozzle is preferably at most 40°. Accordingly, the cleaning liquid is unlikely to leak beyond the spray-target regions, further improving the cleaning performance.

The spray units preferably each includes a slit nozzle. The slit nozzle easily provides a long linear spray pattern with a constant spray volume, reducing any designing restrictions of the device.

The spray units according to the present invention preferably each includes a uniform spray nozzle adapted to keep a uniform flow rate irrespective of positions where the spray-target regions are located. Accordingly, a reliable cleaning performance with no cleaning irregularity is certainly exerted.

The spray unit according to the present invention preferably each temporarily stops the spray of the cleaning liquid at times when the electronic component transported by the transport unit is passing through the spray-target regions. Accordingly, any accidental damage to the electronic component by the sprayed cleaning liquid is prevented from happening.

The present invention provides an electronic component cleaning method for cleaning a site to be cleaned of an electronic component, wherein

an electronic component cleaning device is prepared, the device comprising a plurality of spray units respectively adapted to spray a cleaning liquid to a plurality of spray-target regions linearly extending, the plurality of spray units each having a spray pattern characterized in that a spray direction when viewed from a direction where the plurality of spray-target regions are linearly extending is perpendicular to a plane including the spray-target region, and the plurality of spray units being disposed such that the plurality of spray-target regions are arranged in juxtaposition each other,

the electronic component is situated such that the site to be cleaned is located at a position between the plurality of the spray-target regions, and

the cleaning liquid sprayed from the plurality of spray units crashes against the plurality of spray-target regions and thereby generates cleaning liquid flows headed for the site to cleaned to clean the site.

The electronic component cleaning method preferably cleans the site to be cleaned using the cleaning liquid flows while transporting the electronic component from one of the spray-target regions on two sides between which the site to be cleaned is interposed to the other spray-target region.

The present invention provides the device and the method particularly suitable for cleaning electronic components in which small clearances having widths of about 50 μm are present. The device and the method provided by the present invention are more particularly suitable for cleaning electronic components having even smaller clearances of about 20 μm in width to the meet the demand of further miniaturization in the future.

### Effect of the Invention

The cleaning device and the cleaning method according to the present invention adapted to clean clearances of electronic components accomplish a high cleaning effect.

The device further comprising the transport unit can consecutively clean electronic components in a simplified structure, wherein the cleaning operation can be automated. Moreover, an in-line cleaning system, wherein the cleaning operation and previous and subsequent treatments are automated altogether, can be successfully built. As a result of the automation, the electronic components can be cleaned with a higher efficiency.

### BRIEF DESCRIPTION OF THE DRAWINGS

FIG. 1 is a side view schematically illustrating an electronic component clearance cleaning device according to an exemplary embodiment 1 of the present invention.

FIG. 2 is a front view schematically illustrating the electronic component clearance cleaning device according to the exemplary embodiment 1.

FIG. 3 is an upper view schematically illustrating the electronic component clearance cleaning device according to the exemplary embodiment 1.

FIG. 4A is a schematic illustration (perspective view) of a mounting substrate of Flip Chip-Ball Grid Array packaging (FC-BGA).

FIG. 4B is a schematic illustration (front view) of the mounting substrate of Flip Chip-Ball Grid Array packaging (FC-BGA).

FIG. 5 is a side view schematically illustrating an electronic component clearance cleaning device according to an exemplary embodiment 2 of the present invention.

FIG. 6 is a front view schematically illustrating a cleaning operation by the electronic component clearance cleaning device according to the exemplary embodiment 2 (FIG. 5).

FIG. 7 is an upper view schematically illustrating a cleaning operation by the electronic component clearance cleaning device according to the exemplary embodiment 2 (FIG. 5).

### EXEMPLARY EMBODIMENTS FOR CARRYING OUT THE INVENTION

Hereinafter, exemplary embodiments of the present invention are described in detail referring to the accompanied drawings. In the exemplary embodiments hereinafter described, a mounting substrate of Flip Chip-Ball Grid Array packaging (hereinafter, called FC-BGA (1)) is used as an electronic component. However, the present invention is not necessarily limited thereto but is applicable to other electronic components.

### Exemplary Embodiment 1 of Cleaning Device

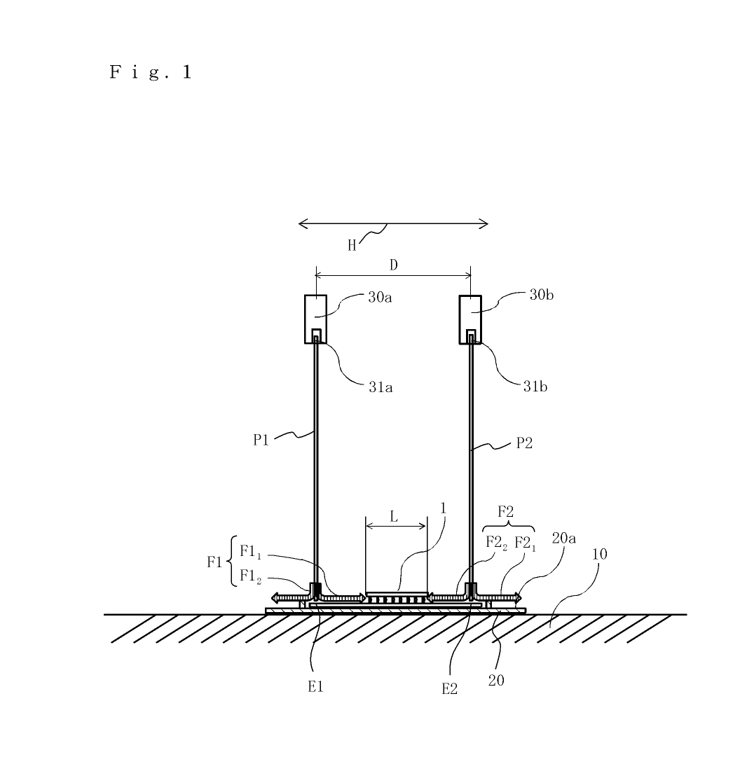

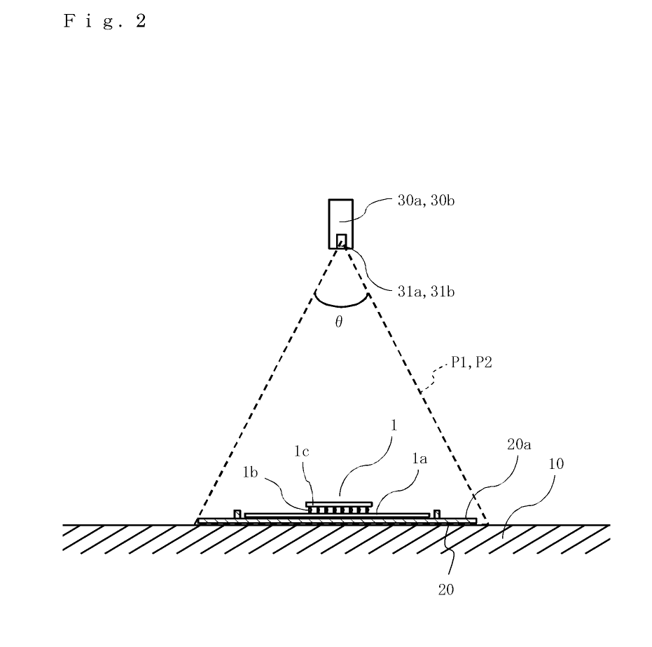

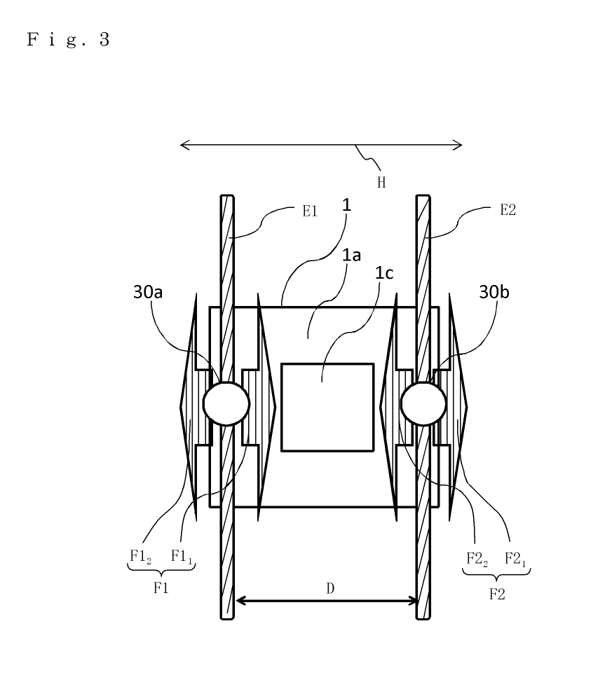

FIG. 1 is a side view schematically illustrating an electronic component clearance cleaning device according to an exemplary embodiment 1 of the present invention. FIG. 2 is a front view of the schematic structure of the cleaning device. FIG. 3 is an upper view of the schematic structure of the cleaning device.

As illustrated in FIG. 1, the cleaning device has a placing portion (10) on which an electronic component, such as FC-BGA (1), is placed, and spray units (30a) and (30b).

The spray unit 30a has a linear spray-target region (E1) set on an upper surface of the placing portion (10). The spray unit (30a) sprays a cleaning liquid according to a spray pattern (P1) to the set spray-target region (E1). The spray pattern (P1) is provided on a plane where a spray direction when viewed from a direction where the spray-target region (E1) is linearly extending (vertical direction facing the drawing of FIG. 1, lateral direction facing the drawing of FIG. 2) is perpendicular to a plane including the spray-target region (E1). The plane including the spray-target region (E1) is, for example, the upper surface of the placing portion (10). The “linear” is preferably the form of a straight line, however, may include the forms of a line curved with a moderate curvature and an undulated line.

The spray unit 30b has a linear spray-target region (E2) set on the upper surface of the placing portion (10). The spray unit (30b) sprays the cleaning liquid according to a spray pattern (P2) to the set spray-target region (E2). The spray pattern (P2) is provided on a plane where a spray direction when viewed from a direction where the spray-target region (E2) is linearly extending (vertical direction facing the drawing of FIG. 1, lateral direction facing the drawing of FIG. 2) is perpendicular to a plane including the spray-target region (E2). The plane including the spray-target region (E2) is specifically the upper surface of the placing portion (10) similarly to the plane including the spray-target region (E1). The spray units (30a) and (30b) are disposed facing each other such that the linear spray-target regions (E1) and (E2) are arranged in juxtaposition each other. The plane including the spray-target region (E1) is not necessarily limited to the upper surface of the placing portion (10). Other examples of the plane will be described later.

Describing “the spray-target regions (E1) and (E2) are arranged in juxtaposition each other”, the spray-target regions (E1) and (E2) may be in parallel with each other, or the spray-target regions (E1) and (E2) may extend so as to intersect with each other through very small angles having an angular difference equal to or smaller than 5°. Describing “the direction is perpendicular to a plane including the spray-target region (E1), (E2)”, the direction may be literally perpendicular to the plane including the spray-target region (E1), (E2), or the direction may include directions having an angle ranging from 85° to 95° to the plane.

A holding tool (20) having a plate shape is detachably attached to the upper surface of the placing portion (10), and the FC-BGA (1), which is an example of the electronic component, is securely fixated to an upper surface (20a) of the holding tool (20).

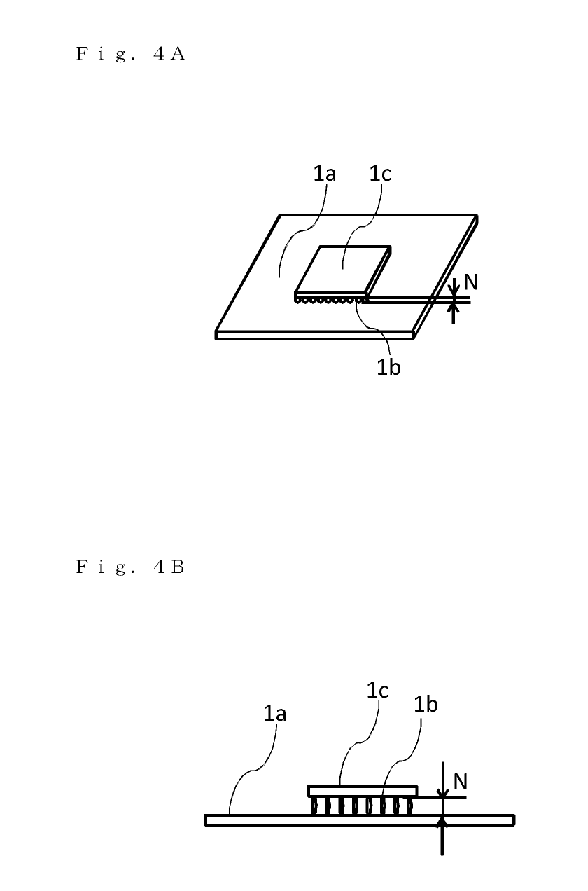

As illustrated in FIGS. 4A and 4B, the FC-BGA (1) has a substrate (1a) and an electronic circuit chip (1c), wherein the substrate (1a) is mounted with the electronic circuit chip (1c) by means of a solder bump (1b). There is a clearance (N) between the substrate (1a) and the electronic circuit chip (1c) where the solder bump (1b) is provided. In the FC-BGA (1), the clearance (N) is a site to be cleaned. A semiconductor device preferably constitutes the electronic circuit chip (1c). An example of the substrate (1a) is a wafer.

As illustrated in FIG. 2, the spray units (30a) and (30b) each includes a fan-type uniform spray nozzle which sprays the cleaning liquid in a fan-like manner through a spray angle (θ) along an axial direction. The spray patterns (P1) and (P2) are characterized in that projection planes thereof when viewed from the spray direction are unidirectionally extending.

To ensure a uniform flow rate of the sprayed cleaning liquid in respective sections of the spray-target regions (E1) and (E2), the spray angles (θ) of the spray units (30a) and (30b) are set to stay in the range of 15° to 40°. Further, the spray units (30a) and (30b) are disposed such that a whole width of the parts of the FC-BGA (1) is included in the spray-target regions (E1) and (E2) by suitably adjusting height dimensions of the nozzles of the spray units (30a) and (30b) in the range of 15 mm to 150 mm relative to the placing portion (10).

The FC-BGA (1) is placed on the upper surface of the placing portion (10). When the flow rates of the cleaning liquid sprayed from the spray units (30a) and (30b) are equal, the FC-BGA (1) is placed at an intermediate position equally distant from the spray-target regions (E1) and (E2). While the FC-BGA (1) is staying on the placing portion (10), the clearance (N) is extending along a direction in parallel with the upper surface (20a) of the holding tool (20) where the FC-BGA (1) is placed. The clearance (N) thus extending is exposed in a facing direction of the spray-target regions (E1) and (E2). The facing direction of the spray-target regions (E1) and (E2) is hereinafter called a spray-target region facing direction (H).

According to the present exemplary embodiment, the fan-type uniform spray nozzles are used as the spray units (30a) and (30b). However, the spray units (30a) and (30b) are not particularly limited as far as they each has a substantially linear spray pattern characterized in that a projection plane thereof when viewed from the spray direction is unidirectionally extending. A slit nozzle, for example, may be used as the spray unit.

The cleaning liquid sprayed from the spray units (30a) and (30b) according to the spray patterns (P1) and (P2) crashes against the spray-target regions (E1) and (E2) and diverges in different directions, thereby generating split cleaning liquid flows (F1) and (F2). The split cleaning liquid flow (F1) is a split cleaning liquid flow generated by the crash against the spray-target region (E1), and the split cleaning liquid flow (F2) is a split cleaning liquid flow generated by the crash against the spray-target region (E2).

The spray-target regions (E1) and (E2) may be provided on the upper surface of the placing portion (10), holding tool (20), or substrate (1a). According to the present exemplary embodiment, the substrate (1a) has a considerably large size as compared to the electronic circuit chip (1c), and the upper surface (20a) of the holding tool (20) where the cleaning liquid crashes is covered by the substrate (1a). Accordingly, the spray-target regions (E1) and (E2) are provided on the upper surface of the substrate (1a), and the plane including the spray-target regions (E1) and (E2) is also provided on the upper surface of the substrate (1a).

The split cleaning liquid flow (F1) includes a pair of cleaning liquid flows (F1₁) and (F1₂) directed opposite to each other along the substrate (1a). Similarly, the split cleaning liquid flow (F2) includes a pair of cleaning liquid flows (F2₁) and (F2₂) directed opposite to each other along the substrate (1a). These cleaning liquid flows (F1₁), (F2₂), (F1₁), and (F2₂) run very fast along the surfaces of the holding tool (20) and the substrate (1a).

The cleaning liquid flow (F1₁) which diverged from the cleaning liquid flow (F1₂) in the spray-target regions (E1) is headed toward the spray-target region (E2) along the substrate (1a). The cleaning liquid flow (F2₂) which diverged from the cleaning liquid flow (F2₁) in the spray-target regions (E2) is headed toward the spray-target region (E2) along the substrate (1a). The cleaning liquid flows (F1₁) and (F2₂) confront each other at an intermediate position between the spray-target regions (E1) and (E2) (intermediate position between the spray patterns (P1) and (P2)), and a liquid flow confronting area is thereby generated. The liquid flow confronting area is an area where paired cleaning liquid flows are confronting each other.

The FC-BGA (1) is held by the holding tool (20) such that the site to be cleaned, clearance (N), is located at a position centered between the spray-target regions (E1) and (E2). Then, the clearance (N) is exposed along the spray-target region facing direction (H) on the upper surface of the substrate (1a) where the liquid flow confronting area is present. When the clearance (N) is thus located, the cleaning liquid flows (F1₁) and (F2₂) oppositely directed smoothly pour into the clearance (N), thereby effectively removing any wastes remaining in the clearance (N) such as flux.

At the time, the spray-target regions (E1) and (E2) are each linearly extending along a direction, and the cleaning liquid flows (F1₁) and (F2₂) are flowing in large width dimensions. Therefore, the clearance (N) can be efficiently cleaned when the FC-BGA (1) is by simply placed at such a position that the clearance (N) stays in the width dimensions of the cleaning liquid flows (F1₁) and (F2₂). Thus, exact positioning, which is conventionally required in, for example, a high-pressure jet cleaning device, is unnecessary for cleaning the clearance (N).

The site to be cleaned of the FC-BGA (1) and an interval distance (D) are described below. As illustrated in FIG. 3, the interval distance (D) between the spray-target regions (E1) and (E2) has a larger dimension than the size of the electronic circuit chip (1c) including the site to be cleaned (clearance (N)) of the FC-BGA (1) along the spray-target region facing direction (H). The FC-BGA (1) according to the present exemplary embodiment has a structure where the substrate (1a) larger in width than the electronic circuit chip (1c) is mounted with the electronic circuit chip (1c), and a section of the FC-BGA (1) subject to the cleaning (site to be cleaned) is the clearance (N) formed below the electronic circuit chip (1c). Therefore, the size of the cleaning site of the FC-BGA (1) along the spray-target region facing direction (H) is not equal to the whole width of the FC-BGA (1) (width of the substrate 1a) but is equal to a width (L) of the electronic circuit chip (1c).

According to the present exemplary embodiment, the interval distance (D) between the adjacent the spray-target regions is larger than the width (L) of the electronic circuit chip (1c) along the spray-target region facing direction (H) when the FC-BGA (1) is placed on the placing portion (10) (D>L). Accordingly, the cleaning liquid flows (F1₁) and (F2₂) which respectively diverged in the spray-target regions (E1) and (E2) and are heading for the FC-BGA (1) along the upper surface of the substrate (1a) smoothly pour into the clearance (N) to remove any wastes left therein.

According to the present exemplary embodiment, the interval distance (D) and the width dimension (L) along the spray-target region facing direction (H) fulfill a relationship expressed by the following formula.

L<D≦(L+25 mm) 1)

As a result, the cleaning liquid flows (F1₁) and (F2₂) which respectively diverged in the spray-target regions (E1) and (E2) and are heading for the FC-BGA (1) along the upper surface of the substrate (1a) pour into the clearance (N) with such a suitably long interval as at most 25 mm plus the width (L) of the electronic circuit chip (1c) which is a conventional width dimension, thereby more effectively removing any wastes remaining in the clearance (N).

To clean an electronic component wherein the clearance (N) has any particular direction (for example, electronic component mounted with a chip component having through holes formed along a direction as the clearance (N)), the electronic component is preferably located such that openings of the through holes (opening of the clearance (N)) face the flow direction of the cleaning liquid (spray-target region facing direction (H)). Examples of the chip component are transistor and capacitor.

There are no restrictions to flow rates of the cleaning liquid flows (F1₁) and (F2₂). The flow rates may be suitably decided depending on electronic components to be cleaned. To clean an electronic component including a semiconductor device mounting substrate, such as the FC-BGA (1), the flow rates are preferably 0.03 to 0.2 msec. to obtain a good penetrability of the cleaning liquid into the clearance (N) and prevent breakage of the electronic circuit chip (1c). The spray units (30a) and (30b) normally spray from the nozzles the cleaning liquid at such low spray pressures as 0.05 to 0.8 MPa. Thus, the cleaning device according to the present invention cleans the clearance (N) without using such a high pressure cleaning liquid at 1.0 to 5.0 MPa that is used in conventional cleaning methods, thereby avoiding breakage of the FC-BGA (1) during the cleaning.

According to the present exemplary embodiment, the electronic circuit chip (1c) is cleaned with the cleaning liquid flows (F1₁) and (F2₂) generated when the cleaning liquid crashes against the spray-target regions (E1) and (E2). Therefore, the cleaning liquid from the spray units (30a) and (30b) is not directly sprayed to the electronic circuit chip (1c). Because of the technical advantage, there is no risk of damaging the electronic circuit chip (1c) in any case where the spray pressures of the spray units (30a) and (30b) need to be increased.

### Exemplary Embodiment 2 of Cleaning Device

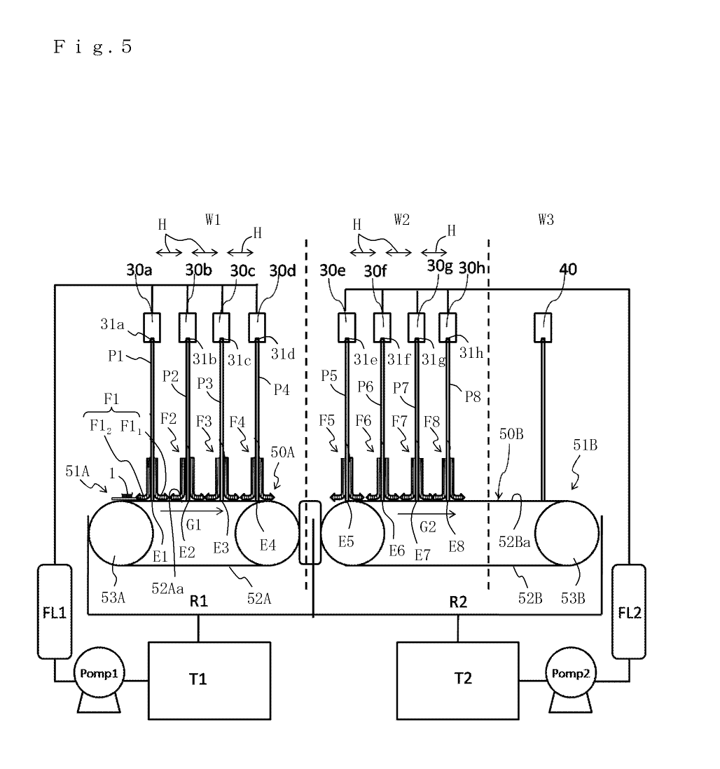

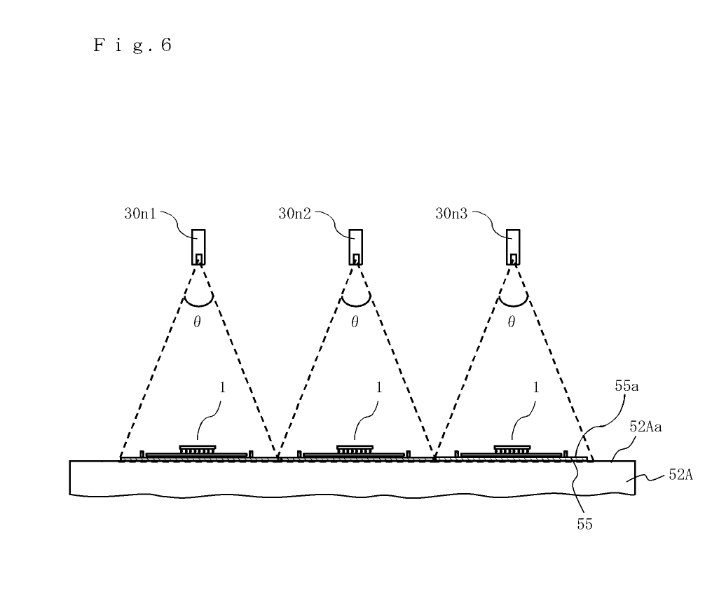

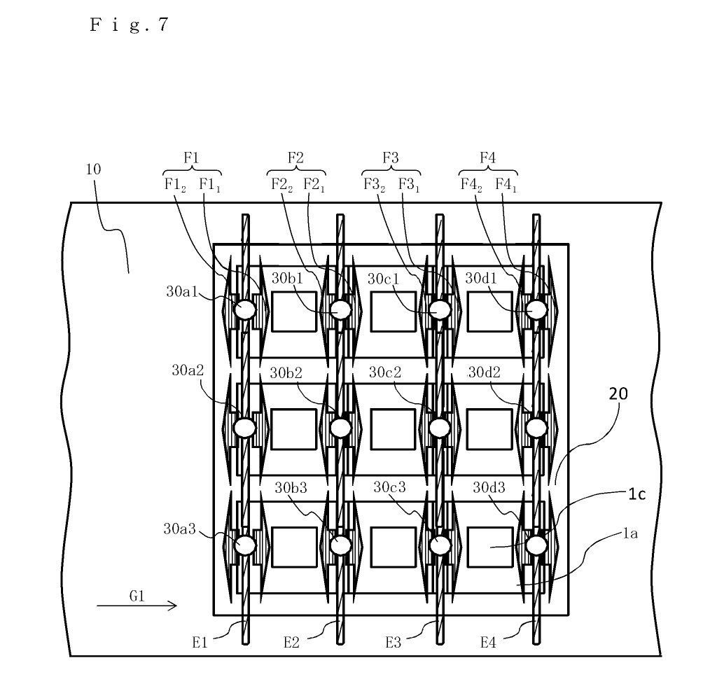

FIG. 5 is a side view schematically illustrating an electronic component clearance cleaning device according to an exemplary embodiment 2 of the present invention. FIG. 6 is a front view of the schematic structure of the cleaning device. FIG. 7 is an upper view of the schematic structure of the cleaning device. The same reference symbols as those of the exemplary embodiment 1 are used in the description hereinafter given.

The exemplary embodiment 2 provides a cleaning device equipped with a transport unit adapted to consecutively transport electronic components. The cleaning device has a device configuration that can be linked to previous devices (for example, reflow treatment device) and subsequent devices (for example, plasma treatment device and under-filling device). The cleaning device has a cleaning unit (W1), a rinsing unit (W2), and a drying unit (W3), wherein the cleaning device described in the exemplary embodiment 1 is embedded in the cleaning unit (W1) and the rinsing unit (W2).

The transport unit and placing portion may be shared among the cleaning unit (W1), rinsing unit (W2), and drying unit (W3). According to the present exemplary embodiment, the transport unit and placing portion are shared by the rinsing unit (W2) and the drying unit (W3). The transport unit and placing portion provided in the cleaning unit (W1) are respectively a transport unit (51A) and a placing portion (50A). The transport unit and placing portion provided in the rinsing unit (W2) and the drying unit (W3) to be thereby shared are respectively a transport unit (51B) and a placing portion (50B).

The transport unit (51A) is equipped with a belt conveyer (52A) and a driver (53A) which drives the belt conveyer (52A). Similarly, the transport unit (51B) is equipped with a belt conveyer (52B) and a driver (53B) which drives the belt conveyer (52B). According to the exemplary embodiment 2, belts of the belt conveyers (52A) and (52B) constitute the placing portions (50A) and (50B), respectively. As illustrated in FIG. 6, holding tools (55) for holding FC-BGAs (1) are respectively detachably attached to upper surfaces (52Aa) and (52Ba) of the belt conveyers (52A) and (52B). Describing the upper surfaces (52Aa) and (52Ba) of the belt conveyers (52A) and (52B), they are the upper surfaces of the belt conveyers (52A) and (52B) ready to transport an article, more specifically parts of the belts looking upward during the transport.

The cleaning devices respectively provided in the cleaning unit (W1) and the rinsing unit (W2) have spray units (30a) to (30h) which spray a cleaning liquid according to a plurality of spray patterns (P1) to (P8) toward the spray-target regions (E1) to (E8) on the belt conveyers (52A) and (52B). The spray units (30a) to (30d) are provided in the cleaning unit (W1), and the spray units (30e) to (30h) are provided in the rinsing unit (W2). In the description below, the cleaning liquid used in the rinsing unit (W2) is called a rinsing liquid.

As illustrated in FIGS. 5 to 7, a plurality of FC-BGAs (1) transported by the belt conveyers (52A) and (52B) are cleaned with the cleaning liquid, rinsed with pure water, and then dried consecutively while they are being transported. During these treatments consecutively performed, the cleaning liquid and the rinsing liquid (pure water) reserved in a cleaning liquid tank (T1) and a pure water tank (T2) are respectively supplied to the spray units (30a) to (30d) and (30e) to (30h) through filters (FL1) and (FL2) by actuating pumps (Pomp1) and (Pomp2). The used cleaning liquid and rinsing liquid are recovered by the respective tanks (T1) and (T2) by way of buffer tanks (R1) and (R2) to be reused.

The spray units (30a) to (30d) are disposed next to one another along a longitudinal axis of the transport unit (51A) in a transport direction (G1). Similarly, the spray units (30e) to (30h) are disposed next to one another along a longitudinal axis of the transport unit (51B) in a transport direction (G2).

Similarly to the exemplary embodiment 1, the spray units (30a) to (30h) each includes a fan-type uniform spray nozzle which sprays the cleaning liquid in a fan-like manner through a spray angle (θ) along an axial direction. The spray units (30a) to (30h) respectively have spray patterns (P1) to (P8). The spray units (30a) to (30h) are disposed so as to meet following requirements; spray ports (31a) to (31d) provided in the nozzles (30a) to (30d) face the belt upper surface (52Aa), spray ports (31e) to (31h) provided in the nozzles (30e) to (30h) face the belt upper surface (52Ba), the spray-target regions (E1) to (E4) are arranged in juxtaposition one another, the spray-target regions (E5) to (E8) are arranged in juxtaposition one another, the spray patterns (P1) to (P4) are perpendicular to the belt upper surface (52Aa), the spray patterns (P5) to (P8) are perpendicular to the belt upper surface (52Ba), a spray-target region facing region (H) in the spray patterns (P1) to (P4) corresponds to the transport direction (G1), a spray-target region (H) in the spray patterns (P5) to (P8) corresponds to the transport direction (G2), and whole widths of the parts of the FC-BGAs (1) are respectively encompassed in the spray-target regions (E1) to (E8) by suitably adjusting height dimensions of the nozzles in the range of 15 mm to 150 mm relative to the belt upper surfaces (52Aa) and (52Ba). These juxtaposed and perpendicular arrangements are employed based on a technical concept similar to that of the exemplary embodiment 1, wherein the belt upper surfaces (52Aa) and (52Ba) are planes where a spray direction of the spray units (30a) to (30h) when viewed from a direction where the spray-target regions (E1) to (E8) are linearly extending includes the spray-target regions (E1) to (E8). The “linear” is preferably the form of a straight line, however, may include the forms of a line curved with a moderate curvature and an undulated line.

Thus structurally characterized, the FC-BGAs (1) transported by the belt conveyers (51A) and (51B) along the transport directions (G1) and (G2) are respectively transported through the spray-target regions (E1) to (E8) along a spray-target region facing direction (H) (corresponds to the transport directions (G1) and (G2) according to the exemplary embodiment 2). During the transport of the FC-BGAs (1), clearances (N) in parallel with the upper surfaces (52Aa) and (52Ba) of the belt conveyers are all exposed along the spray-target region facing direction (H).

According to the exemplary embodiment 2, the fan-type uniform spray nozzles are used as the spray units (30a) to (30h). However, the spray units (30a) to (30h) are not particularly limited as far as they each has a substantially linear spray pattern characterized in that a projection plane thereof when viewed from the spray direction is unidirectionally extending. A slit nozzle, for example, may be used as the spray unit.

The cleaning liquid and the rinsing liquid sprayed from the spray ports (31a) to (31h) of the spray units (30a) to (30h) according to the spray patterns (P1) to (P8) crash against the spray-target regions (E1) to (E8) and diverge in different directions, thereby generating split cleaning liquid flows. Hereinafter, the split cleaning liquid flows are respectively called according to the spray patterns; split cleaning liquid flows (F1) to (F4), and split cleaning liquid flows (F5) to (F8). The split cleaning liquid flows (F1) to (F4) are headed for the spray-target regions (E1) to (E4), and the split cleaning liquid flows (F5) to (F8) are headed for the spray-target regions (E5) to (E8). The split cleaning liquid flows (F1) to (F8) include pairs of cleaning liquid flows [(F1₁) and (F1₂)] to [(F8₁) and (F8₂)] respectively oppositely directed along the belt upper surfaces (52Aa) and (52Ba). The cleaning liquid flows [(F1₁) and (F1₂)] to [(F8₁) and (F8₂)] run very fast along the belt upper surfaces (52Aa) and (52Ba) and the surface of the substrate (1a).

The split cleaning liquid flows (F1) to (F8) are described below. The split cleaning liquid flows (F1) to (F8) are basically similarly characterized. In the description below, therefore, split cleaning liquid flows (Fn−1), (Fn), and (Fn+1) are used to describe the split cleaning liquid flows (F1) to (F8), cleaning liquid flows [(Fn−1₁) and (Fn−1₂)], [(Fn₁) and (Fn₂)], and [Fn+1₁] are used to describe the cleaning liquid flows [(F1₁) and (F1₂)] to [(F8₁) and (F8₂)], and spray-target regions (En−1), (En), and (En+1) are used to describe the spray-target regions (E1) to (E8), where n represents natural numbers.

The split cleaning liquid flow (Fn) includes a pair of cleaning liquid flows [(Fn₁) and (Fn₂)] oppositely directed along the substrate (1a). The split cleaning liquid flow (Fn+1) includes a pair of cleaning liquid flows [(Fn+1₁) and (Fn+1₂)] oppositely directed along the substrate (1a). The split cleaning liquid flow (Fn−1) includes a pair of cleaning liquid flows [(Fn−1₁) and (Fn−1₂)] oppositely directed along the substrate (1a).

The cleaning liquid flow (Fn₁) which diverged from the cleaning liquid flow (Fn₂) in the spray-target region (En) is headed toward the spray-target region (En+1) along the substrate (1a). The cleaning liquid flow (Fn₂) which diverged from the cleaning liquid flow (Fn−1₁) in the spray-target region (En) is headed toward the spray-target region (En−1) along the substrate (1a). The cleaning liquid flow (Fn+1₂) which diverged from the cleaning liquid flow (Fn+1₁) in the spray-target region (En+1) is headed toward the spray-target region (En) along the substrate (1a). The cleaning liquid flow (Fn−1₁) which diverged from the cleaning liquid flow (Fn−1₂) in the spray-target region (En−1) is headed toward the spray-target region (En) along the substrate (1a). The cleaning liquid flow (Fn₁) and the cleaning liquid flow (Fn+1₂) confronting each other at an intermediate position between the spray-target regions (En) and (En+1) on the placing portion (10) generate a liquid flow confronting area. The cleaning liquid flow (Fn₂) and the cleaning liquid flow (Fn−1₁) confronting each other at an intermediate position between the spray-target regions (En) and (En−1) on the placing portion (10) generate a liquid flow confronting area.

The belt conveyers (52A) and (52B) are positioned such that the clearances (N) of the FC-BGAs (1) are respectively located at substantially center positions between the adjacent spray-target regions, and the transport units (51A) and (51B) endlessly drive the belt conveyers (52A) and (52B) to transport the plural FC-BGAs (1) on the belt upper surfaces (52Aa) and (52Ba). Then, the FC-BGAs (1) with their clearances (N) exposed along the spray-target region facing direction (H) keep arriving at and moving through the liquid flow confronting areas on both sides of the spray-target regions (En) one after another. The transport rates of the transport units (51A) and (51B) are 100 to 1,500 mm/min. These transport rates effectively reduce adverse impacts possibly exerted on the cleaning effect by any interference between the electronic components being transported and the cleaning liquid flows. The transport rates thus set further ensure a satisfactory volume of production and leads to downsizing of the cleaning device. When the FC-BGAs (1) are thus transported, the cleaning liquid flows oppositely directed [(Fn−1₁) and (Fn₂)] and [(Fn₁) and (Fn+1₂)] are smoothly poured into the clearances (N) of the plural FC-BGAs (1). As a result, any wastes left in the clearances (N), such as flux, are effectively removed therefrom.

Because the spray-target regions (E1) to (E8) are linearly extending, the split cleaning liquid flows (F1) to (F8) are flowing in large width dimension. Therefore, when the belt conveyers (52A) and (52B) are installed such that the electronic circuit chips (1c) of the FC-BGAs (1) stay in the width dimensions of the split cleaning liquid flows (F1) to (F8) flowing along the belt upper surfaces (52Aa) and (52Ba), the clearances (N) are thoroughly cleaned in a time-efficient manner.

According to the present exemplary embodiment so far described, the FC-BGAs (1) transported from the previous device into the cleaning unit (W1) and the rinsing unit (“) are placed on the moving conveyer belts (52A) and (52B) and pass through the plural liquid flow confronting areas as illustrated in FIG. 5. Accordingly, the clearances (N) are cleaned more than once with the cleaning liquid flows oppositely directed, and any wastes left in the clearances (N), such as flux, are effectively removed therefrom.

Below is described a structural example where the conveyer belts (52A) and (52B) have width dimensions smaller than width dimensions of the spray-target regions (E1) to (E8) of the spray units (30a) to (30h) to clean a large number of FC-BGAs (1) are tandemly arrayed in rows in a belt width direction at once per row.

As illustrated in FIG. 6, plural spray units are provided at positions in an upper direction of the belt. FIGS. 6 and 7 illustrate an example in which three spray units (30n1) to (30n3) are provided at the positions. The spray-target regions (En1) to (En3) of the spray units (30n1) to (30n3) are arranged in a row in a direction orthogonal to the transport directions (G1) and (G2). The number of the spray units to be provided is decided such that a whole width of the conveyer belts (52A) and (52B) (more specifically, widths of electronic components arrayed in a row along the belt widths) is encompassed in the spray-target regions (En1) to (En3) arranged in a row.

Thus structurally characterized, the split cleaning liquid flows as large in width dimension as the belt widths can be generated. Accordingly, a large number of FC-BGAs (1) can be cleaned at once. When, for example, the FC-BGA (1) is simply placed at any arbitrary position on the conveyer belt (52A), (52B), the cleaning liquid flows oppositely directed can be surely poured into the clearance (N) of the FC-BGA (1) three times as the conveyer belt (52A), (52B) moves. Therefore, it is unnecessary to exactly position the FC-BGA (1).

As described, the clearance cleaning operation by the cleaning device according to the present invention does not require exact positioning of the electronic component, and the cleaning operation can be easily performed in combination with any automatic transport device conventionally used. The cleaning operation can be easily automated and coordinated with previous and subsequent treatments (in-line system), wherein the clearance can be cleaned in a time-efficient manner with a high cleaning performance.

According to the present exemplary embodiment, the FC-BGAs (1) placed on the conveyer belts (52A) and (52B) directly pass through the spray-target regions (E1) to (E8) of the spray units (30a) to (30h). As described in the exemplary embodiment 1, however, it is unlikely to damage or break the FC-BGA (1) because the cleaning liquid is normally sprayed from the nozzles at such a low pressure as about 0.05 to 0.8 MPa. In the case where the nozzle spray pressure is increased for a better cleaning performance or the FC-BGAs (1) to be cleaned are rather fragile, the spray units (30a) to (30h) preferably suspend the spray of the cleaning liquid and the rinsing liquid at times when the electronic circuit chips (1c) of the FC-BGAs (1) are passing through the spray-target regions (E1) to (E8) and intensively spray the cleaning liquid and the rinsing liquid anytime other than the suspension periods. The spray units (30a) to (30h) may coordinate spray on/off timings and timings of moving and stopping the conveyer belts (52A) and (52B) according to takt time. Whichever of the methods is employed, the spray units (30a) to (30h) temporarily stop spraying the cleaning liquid at times while the FC-BGAs (1) transported by the transport units (51A) and (51B) are in the spray-target regions (E1) to (E8), thereby effectively cleaning the clearances (N) while preventing the FC-BGAs (1) from breaking.

The FC-BGA (1) already cleaned by the cleaning unit (W1) is transported to the rinsing unit (W2) by a transport device not illustrated in the drawings. The FC-BGA (1) rinsed by the rinsing unit (W2) is then transported to the drying unit (W3) by the transport unit (51B). The drying unit (W3) is equipped with an air nozzle (40) which blows dry hot air to the FC-BGA (1). After the FC-BGA (1) is dried by the drying unit (W3), a sequence of steps of the electronic component cleaning operation ends. After the cleaning operation is over, the FC-BGA (1) is transported from the conveyer belt (52B) to a subsequent treatment device by a transport device not illustrated in the drawings.

### Working Examples

1. Clearance Cleaning Performance Test

### Preparation of Sample for Assessment of Clearance Cleaning Performance

0.1 g of a water-soluble flux commercially available (product name “ALPHA WS-9190”, supplied by Cookson Electronics Co.) was spread on a Cu test piece (0.3 mm×40 mm×40 mm) and heated for 30 seconds under atmosphere on a hot plate at 270° C. to prepare a water-soluble flux residue. Then, a solder resist test substrate (made from 1.0 mm×40 mm×40 mm glass epoxy medium coated with a solder resist) having 60×60 solder bumps (bump diameter: 120 μm, bump height: 30 μm, pitch: 180 μm) arranged thereon like a square was prepared, and the bumps of the test substrate were coated with the water-soluble flux residue. A transparent glass chip (0.5 mm×16 mm×16 mm), supplied by Matsunami Glass Ind., Ltd.) was bonded to the test substrate coated with the flux residue such that the glass chip contacted peaks of the bumps). The glass chip-attached test substrate was heated for 20 seconds at the peak temperature of 260° C. in a reflow oven. The resulting glass chip-attached test substrate was used as a sample for assessing a clearance cleaning performance.

Test Method

An in-line belt conveyance cleaning device of shower type characterized as described in the exemplary embodiment 2 (FIGS. 5 to 7) was used to clean the assessment sample to assess a cleaning performance of the device. Because the water-soluble flux residue was used in the assessment sample of the test, a deonized water at the liquid temperature of 40° C. was used as a cleaning liquid in the cleaning unit (W1), and the assessment sample was cleaned with the deonized water. The rinsing unit (W2) was inactive. Then, the assessment sample was transported to the drying unit (W3), and dry air was blown to the assessment sample through the air nozzle to remove any water drops from the clearance. The assessment sample was observed from an upper surface of the transparent glass chip to detect whether the flux residue remained in the clearance, and a flux residue removal ratio was calculated from the following formula 2) based on area dimensions of the sample where the flux residue was attached before and after the cleaning. Then, a value thereby obtained value was assessed based on assessment criteria described later.

C=100−(G1÷G2)+100 2)

In the formula 2), C is the flux residue removal ration (%), G1 is the area dimension of the sample where the flux residue was attached after the cleaning, and G2 is the area dimension of the sample where the flux residue was attached before the cleaning

Similarly to the illustration of FIG. 5, cleaning nozzles (30a) to (30d) were respectively disposed at four positions along an axial line in a transport direction. The cleaning nozzle at each row position included a group of nozzles (three cleaning nozzles)

### Working Example 1

As the spray units (30a) to (30h) were used fan-type uniform spray nozzles (supplied by H.IKEUCHI Co.,LTD.) having linear spray-target regions (E1) to (E8), wherein a height dimension from spray ports of the spray units (30a) to (30h) to the spray-target regions (E1) to (E8) was 60 mm, a spray pressure of the spray units (30a) to (30h) was 0.3 MPa, and a spray angle of the spray units (30a) to (30h) was 40°.

The spray units (30a) to (30h) were situated such that a spray direction when viewed from a direction where the spray-target regions (E1) to (E8) are linearly extending is perpendicular to a plane including the spray-target regions (E1) to (E8). An interval distance (D) of the spray-target regions (E1) to (E8) (distance of lines connecting the spray ports of the spray units) was 28 mm. An average flow rate of generated cleaning liquid flows (F1₁)to (F2₂) was 0.03/sec.

An average flow rate of the cleaning liquid flows (F1₁) to (F2₂) was calculated as described below; flow rates per unit time for the cleaning liquid flows (F1₁) to (F2₂) to flow along the plane including the spray-target regions (E1) to (E8) were measured, and the measured values of flow rates were divided by sectional area dimensions in width direction (mm²) of the cleaning liquid flows (F1₁) to (F2₂) to use the divided value the as average flow rate of the cleaning liquid flows (F1₁) to (F2₂). The sectional area dimensions in width direction (mm²) of the cleaning liquid flows (F1₁) to (F2₂) were calculated by a calculation formula (height of cleaning liquid flow x spray pattern length of cleaning nozzle). The height dimension of the cleaning liquid flows (F1₁) to (F2₂) was calculated by a calculation formula (opening width of nozzle spray port÷2).

### Working Examples 2 to 5, Working Examples 7 to 9

These working examples were similar to the working example 1 except that the interval distance (D) of the spray-target regions (E1) to (E8), and the spray pressure and spray angle were changed to those illustrated in Table 1.

### Working Example 6

This working example was similar to the working example 1 except that slit nozzles (Water Curtain Nozzle, supplied by Spraying Systems Co., Japan) were used as the spray units (30a) to (30h).

### Comparative Example 1

This working example was similar to the working example 1 except that full cone nozzles (small flow rate, supplied by Spraying Systems Co., Japan) were used as the spray units (30a) to (30h).

### Comparative Example 2

The spray-target region (E1) of the spray unit (30a) in the front row was disposed with a tilt through 45° relative to the spray-target region facing direction (H). Further, the spray-target region (E2) of the spray unit (30b) in the second row was disposed with a tilt through 45° relative to the spray-target region facing direction (H) so that the spray-target region (E2) was in proximity to the spray-target region (E1) of the spray unit (30a) (these regions are not in parallel with each other). The spray units (30c) and (30d) in the third and fourth rows were similarly positionally adjusted. As a result, the adjacent ones of all of the spray-target regions (E1) to (E8) were all disposed in non-parallel with each other. The rest of the comparative example 2 is similar to the working example 1.

### Comparative Example 3

The cleaning device according to the exemplary embodiment (FIGS. 1 to 3) was used, where the spray direction of the spray units (30a) and (30b) when viewed from a direction where the spray-target regions (E1) and (E2) are linearly extending was tilted through 45° to a plane including the spray-target regions (E1) and (E2) in the same direction. The rest of the comparative example 3 is similar to the working example 1.

The assessment sample was set in the in-line cleaning devices according to the working examples and cleaned over a length of time necessary for the cleaning of the assessment sample to be completed (one minute) and then dried similarly to the working example 1.

Cleaning Performance Assessment Criteria

The assessment samples were respectively visually observed from the upper surfaces of the glass chip. The ratios of the area dimensions to which the flux residue was attached before and after the cleaning were calculated, and obtained results were assessed based on the following assessment criteria.

¤ flux residue removal ratio=100%
∘ flux residue removal ratio=at least 95% and less than 100%
Δ A flux residue removal ratio=at least 60% and less than 95%
x flux residue removal ratio=less than 60%

Clearance Cleaning Test Result

Table 1 shows assessment results of the samples cleaned in the working examples 1 to 9 and the comparative examples 1 to 3 (flux residual removal ratios). As is clear from Table 1, the working examples 1 to 9 obtained higher flux residue removal ratios as compared to the comparative examples 1 to 3. The assessment results of the comparative examples 2 and 3 showing A were more specifically, flux residue removal ratio=70% in the comparative example 2, and flux residue removal ratio=65% in the comparative example 3.

TABLE 1

| | | | | | | | spray-target | | |
|---|---|---|---|---|---|---|---|---|---|
| | | | | spray | spray | | region | flow | |
| | nozzle | spray | | pressure | angle | spray | distance | rate | |
| | type | pattern | row pattern | (MPa) | (°) | direction | (mm) | (m/s) | Result |
| working | fan | linear | parallel | 0.3 | 40 | perpendicular | 28 | 0.03 | [symbol] |
| example 1 | type | | | | | | | | |
| working | fan | linear | parallel | 0.3 | 40 | perpendicular | 17 | 0.03 | [symbol] |
| example 2 | type | | | | | | | | |
| working | fan | linear | parallel | 0.3 | 40 | perpendicular | 38 | 0.03 | [symbol] |
| example 3 | type | | | | | | | | |
| working | fan | linear | parallel | 0.3 | 40 | perpendicular | 50 | 0.03 | ∘ |
| example 4 | type | | | | | | | | |
| working | fan | linear | parallel | 0.3 | 50 | perpendicular | 28 | 0.03 | ∘ |
| example 5 | type | | | | | | | | |
| working | slit | linear | parallel | 0.3 | 40 | perpendicular | 28 | 0.03 | [symbol] |
| example 6 | type | | | | | | | | |
| working | fan | linear | parallel | 0.05 | 40 | perpendicular | 28 | 0.03 | [symbol] |
| example 7 | type | | | | | | | | |
| working | fan | linear | parallel | 0.8 | 40 | perpendicular | 28 | 0.03 | [symbol] |
| example 8 | type | | | | | | | | |
| working | fan | linear | parallel | 0.8 | 40 | perpendicular | 28 | 0.2 | [symbol] |
| example 9 | type | | | | | | | | |
| comparative | full | circular | parallel | 0.3 | 40 | perpendicular | 28 | 0.03 | x |
| example 1 | cone | | | | | | | | |
| | type | | | | | | | | |
| comparative | fan | linear | non-parallel | 0.3 | 40 | perpendicular | — | 0.03 | Δ |
| example 2 | type | | | | | | | | |
| comparative | fan | linear | parallel | 0.3 | 40 | 45° | 28 | 0.03 | Δ |
| example 3 | type | | | | | | | | |

Cleaning-Caused Damage Test

### Preparation of Sample for Cleaning-Caused Damage Test

A silicon wafer (0.1 mm×10 mm×10 mm) was bonded to the bumps of the solder resist test substrate used to prepare the assessment sample to obtain a damage assessment sample.

Test Method

An in-line belt conveyance cleaning device of shower type characterized as described as described in the exemplary embodiment 2 (FIGS. 5 to 7) was used to clean the damage assessment sample at the transport rate of 300 mm/min.

### Working Example 10

This working example was carried out under requirements similar to those of the working examples 1 and 8 of the clearance cleaning test.

### Comparative Example 4

A shower cleaning device similar to that of the comparative example 3 of the clearance cleaning test (see the exemplary embodiment 1 (FIGS. 1 to 3) was, in which the spray angle of the spray unit (30a) alone was changed to 45°. A high pressure cleaning liquid at the spray pressure of 1.0 MPa was directly sprayed from the angled-changed spray unit (30a) alone to the clearance of the set damage assessment sample for cleaning for one minute similarly to the cleaning of the damage assessment samples in the working examples.

Test Result

Though there was no breakage in the damage assessment sample in the working example 10, the wafer of the assessment sample underwent some cracks in the comparative example 4.

### INDUSTRIAL APPLICABILITY

The present invention provides a very advantageous cleaning device and method best used to clean clearances of electronic components, for example, substrates mounted with various semiconductor devices such as electronic circuit chip, transistor, capacitor, and diode.

### DESCRIPTION OF REFERENCE SYMBOLS

### 1 FC-BGA

1a substrate
1b solder bump
1c electronic circuit chip
10 placing portion
20 holding tool
20a upper surface of holding tool
30a-30h spray unit
30a, 31b spray port
50A, 50B placing portion
51A, 51B transport unit
52A, 52B belt conveyer
52Aa, 52Ba upper surface of belt
53A, 53B driver
55 holding tool

55a upper surface of holding tool

N clearance
θ spray angle
D interval distance between spray-target regions
E1-E8 spray-target region
F1-F8 split cleaning liquid flow
F1₁, F1₂-F8₁, F8₂ cleaning liquid flow
G transport direction
H spray-target region facing direction
L width dimension of electronic circuit chip
P1-P8 spray pattern
T1, T2 tank
Pomp1, Pomp2 liquid feed pump
FL1, FL2 filter
R1, R2 buffer tank
W1 cleaning unit
W2 rinsing unit
W3 drying unit

What is claimed is:

1. An electronic component cleaning device for cleaning a site to be cleaned of an electronic component, comprising a plurality of spray units respectively adapted to spray a cleaning liquid to a plurality of spray-target regions between which the site to be cleaned is interposed, wherein
the plurality of spray-target regions are linearly extending,
the plurality of spray-target regions each has a spray pattern characterized in that a spray direction when viewed from a direction where the plurality of spray-target regions are linearly extending is perpendicular to a plane including the spray-target region,
the plurality of spray units are disposed such that the plurality of spray-target regions are arranged in juxtaposition each other, and
the cleaning liquid sprayed from the plurality of spray units crashes against the plurality of spray-target regions and thereby generates cleaning liquid flows headed for the site to cleaned.

2. The electronic component cleaning device as claimed in claim 1, wherein
the site to be cleaned includes a clearance of the electronic component exposed toward the spray-target regions.

3. The electronic component cleaning device as claimed in claim 2, wherein
the electronic component comprises a substrate or a wafer and an electronic circuit chip mounted on the substrate or the wafer, wherein the clearance is formed between the substrate or the wafer and the electronic circuit chip.

4. The electronic component cleaning device as claimed in claim 1, further comprising a transport unit adapted to transport the electronic component from one of the spray-target regions on two sides between which the site to be cleaned is interposed to the other spray-target region.

5. The electronic component cleaning device as claimed in claim 4, wherein
an interval distance from one of the spray-target regions on two sides between which the site to be cleaned is interposed to the other spray-target region is larger than a size of the site to be cleaned along a facing direction of the spray-target region on one of the two sides and the spray-target region on the other side.

6. The electronic component cleaning device as claimed in claim 4, wherein
the electronic component comprises a substrate or a wafer and an electronic chip mounted on the substrate or the wafer, wherein an interval distance D from one of the spray-target regions on two sides between which the site to be cleaned is interposed to the other spray-target region and a width dimension L of the electronic component along a facing direction of the spray-target region on one of the two sides and the spray-target region on the other side fulfills a relationship expressed by the formula L<D≦(L+25 mm).

7. The electronic component cleaning device as claimed in claim 4, wherein
the transport unit transports the electronic component at a transport rate from 100 to 1,500 mm/min.

8. The electronic component cleaning device as claimed in claim 1, wherein
a flow rate of the cleaning liquid flow sprayed from the spray units is from 0.03 msec. to 0.2 m/sec., and a spray pressure by the spray units is from 0.05 MPa to 0.8 MPa.

9. The electronic component cleaning device as claimed in claim 1, wherein
the spray unit includes a fan-type nozzle.

10. The electronic component cleaning device as claimed in claim 9, wherein
a cleaning liquid spray angle of the fan-type nozzle is at most 40°.

11. The electronic component cleaning device as claimed in claim 1, wherein
the spray unit includes a slit nozzle.

12. The electronic component cleaning device as claimed in claim 4, wherein
the spray unit each temporarily stops the spray of the cleaning liquid at times when the electronic component transported by the transport unit is passing through the spray-target regions.

13. An electronic component cleaning method for cleaning a site to be cleaned of an electronic component, wherein
an electronic component cleaning device is prepared, the device comprising a plurality of spray units respectively adapted to spray a cleaning liquid to a plurality of spray-target regions linearly extending, the plurality of spray units each having a spray pattern characterized in that a spray direction when viewed from a direction where the plurality of spray-target regions are linearly extending is perpendicular to a plane including the spray-target region, and the plurality of spray units being disposed such that the plurality of spray-target regions are arranged in juxtaposition each other,
the electronic component is situated such that the site to be cleaned is located at a position between the plurality of the spray-target regions, and
the cleaning liquid sprayed from the plurality of spray units crashes against the plurality of spray-target regions and thereby generates cleaning liquid flows headed for the site to cleaned to clean the site.

14. The electronic component cleaning method as claimed in claim 13, wherein
the electronic component cleaning method cleans the site to be cleaned using the cleaning liquid flows while transporting the electronic component from one of the spray-target regions on two sides between which the site to be cleaned is interposed to the other spray-target region.
